(19) United States
(12) Patent Application Publication
(10) Pub. No.: US 2005/0171809 A1
(43) Pub. Date: Aug. 4, 2005

(54) Event processing engine

(75) Inventors: Moshe Klein, Woodland Hills, CA (US); Alon Shwartz, Woodland Hills, CA (US); Jim Zafrani, Woodland Hills, CA (US)

Correspondence Address: MARVIN H. KLEINBERG;KLEINBERG & LERNER, LLP, Suite 1080, 2049 Century Park East, Los Angeles, CA, 90067, US

(73) Assignee: Synthean Inc.

(21) Appl. No.: 11/046,992

(22) Filed: Jan. 31, 2005

Related U.S. Application Data
(63) Continuation-in-part of application No. 10/898,464, filed on Jul. 23, 2004.
(60) Provisional application No. 60/540,960, filed on Jan. 30, 2004.
(60) Provisional application No. 60/540,961, filed on Jan. 30, 2004.
(60) Provisional application No. 60/540,964, filed on Jan. 30, 2004.
(60) Provisional application No. 60/540,959, filed on Jan. 30, 2004.
(60) Provisional application No. 60/540,962, filed on Jan. 30, 2004.

(51) Int. Cl. G06F 17/60

(52) U.S. Cl. 705/1; 705/11; 705/9

(57) ABSTRACT

A method of modeling business activities using a computer including the capture of event data for those business activities. Automatic modeling of business activities and playback of completed transactions or events may also be done.

This application claims priority as a continuation in part of the provisional patent applications: Checkpoint Processing Engine, Ser. No. 60/540,959 filed Jan. 30, 2004; Event Capture Engine, Ser. No. 60/540,961 filed Jan. 30, 2004; Information Provider Engine, Ser. No. 60/540,960 filed Jan. 30, 2004; Business Activity Architect, Ser. No. 60/540,964 filed Jan. 30, 2004; Transaction Processing Engine, Ser. No. 60/540,962 filed Jan. 30, 2004 and the non-provisional patent application Universal Transaction Identifier Ser. No. 10/898,464 filed Jul. 23, 2004.

### BACKGROUND

1. Field of the Invention

The present invention relates to business processes, and more specifically to a system for modeling business activities for monitoring events and pulling event data out of events in an instance of a business activity.

2. Background of the Invention

Businesses operate via business activities, which are complex composites of sub- or micro-processes logically connected in the context of a common objective. For example, for a user of an internet website who is ordering a product, several different and distinct processes take place that all relate to the single transaction of purchasing the product. A web server delivers web pages with the requested content to the user. A database server provides some of the content. A credit card verification server ensures that payment is validated. A shipping server might take care of automating the shipping process. Finally, an inventory server could decrement the inventory list for the item demonstrating that one has been purchased. Any number of other servers and networked interactions can take place in effecting a single transaction.

In the prior art, the tracking of a single instance of a business activity has been relatively difficult. Capturing the data associated with each step in an instance of a business activity has been even more difficult. In prior art solutions, a single unique transaction identifier has been required to be passed from each server to server or process to process along the way to the completion of the entire instance of the business activity. Alternatively, an event within an instance of a business activity would be evaluated by going to the server or process that failed and receiving a single report from that server or process. For example, if a credit card server failed to properly process a charge to a customer, the only report of what occurred would exist in the records of the credit card server itself. This problem is only exacerbated when multiple instances of business activities fail at a particular server or process or several servers or processes and the business needs timely information in order to address these issues efficiently and effectively.

It is therefore an object of the present invention to provide a means by which business activities may be modeled effectively, such that each event and each event or checkpoint and all associated event data used in the event may be captured for use in monitoring and evaluating instances of business activities. It is another object of the present invention to provide for simple configuration of the business activity models produced. It is a further object of this invention to provide a means by which the business activities may be wholly or partially modeled automatically. It is another object of the invention to capture data that may or may not be known to be associated with a particular instance of a business activity or a business activity in general. These and other objectives of the present invention will become apparent from the following description of the invention.

### SUMMARY OF THE INVENTION

A method of modeling business activities so that data produced by the various portions of the business activity may be captured. Capturing said data to prepare for correlation to an instance of a business activity.

### BRIEF DESCRIPTION OF THE DRAWINGS

FIG. 1 is a block diagram showing the elements of a computer system which can be used to implement the present invention.

FIG. 2 illustrates the elements of a sample IT infrastructure that may be used by a business enterprise.

FIG. 3 illustrates the various systems used in a representative business activity using the sample IT infrastructure.

FIG. 4 is a series of checkpoints in an example business activity using the elements in FIG. 3.

FIG. 5 is an example of the elements that may be included in a transaction that may be in each event monitored by this process.

FIG. 6 is a depiction of the information technology infrastructure from FIG. 3 along with example event data that may be included in each element.

FIG. 7 is a flow-chart depicting the steps in the automatic business activity detection process.

FIG. 8 is a flow-chart depicting the steps in the event capture process.

### DETAILED DESCRIPTION OF THE INVENTION

The present invention provides a method, implemented on a computer system, for modeling business activities and for using this model to extract business data from individual events (or checkpoints) in a particular business activity. In the following description, specific method steps and procedures are described in order to give a more thorough understanding of the present invention In some instances, specific details are included in order to further clarify the invention. However, in other instances, well known elements such as the computer's operating system and specific software functions are not described in detail so as not to obscure the present invention unnecessarily.

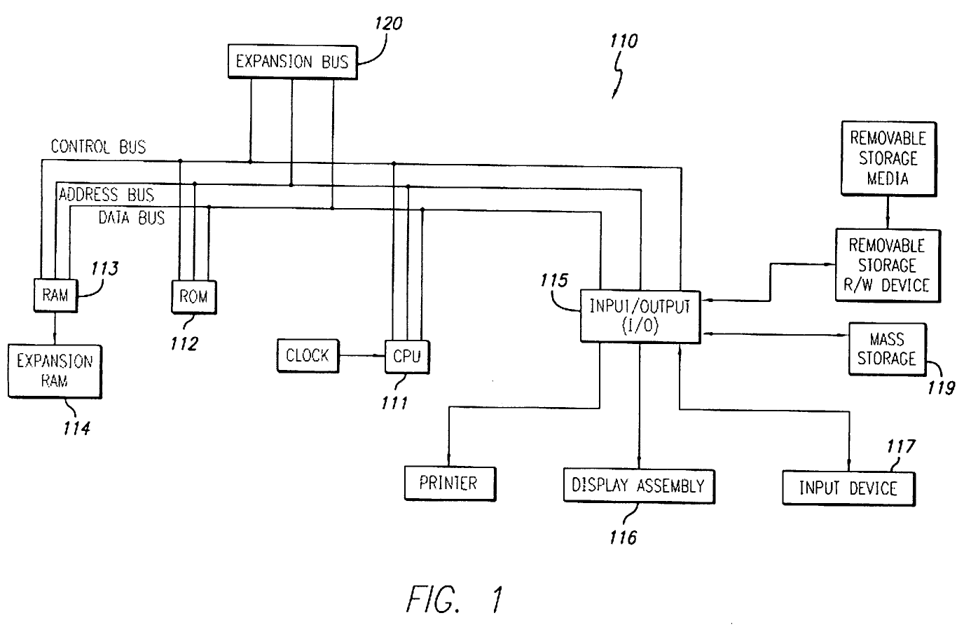

Referring first to FIG. 1, a block diagram of a general purpose computer system which may be used to implement the method of the present invention is illustrated. Specifically, FIG. 1 shows a general purpose computer system 110 for use in practicing the present invention. As shown in FIG. 1, computer system 110 includes a central processing unit (CPU) 111, read-only memory (ROM) 112, random access memory (RAM) 113, expansion RAM 114, input/output (I/O) circuitry 115, display assembly 116, input device 117, and expansion bus 120. The computer system 110 may also optionally include a mass storage unit 119 such as a disk drive unit or nonvolatile memory such as flash memory and a real-time clock 121.

Some type of mass storage 119 generally is considered desirable. However, mass storage 119 can be eliminated by providing a sufficient mount of RAM 113 and expansion RAM 114 to store user application programs and data. In that case, RAMs 113 and 114 can optionally be provided with a backup battery to prevent the loss of data even when computer system 110 is turned off. However, it is generally desirable to have some type of long term mass storage 119 such as a commercially available hard disk drive, nonvolatile memory such as flash memory, battery backed RAM, PC-data cards, or the like. The controlled vocabulary data which is stored in the present invention will be generally stored on mass storage device 119.

In operation, information is input into the computer system 110 by typing on a keyboard, manipulating a mouse or trackball, or “writing” on a tablet or on a position-sensing screen of display assembly 116. CPU 111 then processes the data under control of an operating system and an application program, such as a program to perform steps of the inventive method described above, stored in ROM 112 and/or RAM 113. CPU 111 then typically produces data which is output to the display assembly 116 to produce appropriate images on its screen.

Suitable computers for use in implementing the present invention are well known in the art and may be obtained from various vendors. The preferred embodiment of the present invention is intended to be implemented on a personal computer system, web server or other business application server. Various other types of computers, however, may be used depending upon the size and complexity of the required tasks. Suitable computers include mainframe computers, multiprocessor computers and workstations.

The present invention can be utilized to enable a business enterprise to examine business activities in a more efficient and cost-effective manner. The term “business activity” as used herein refers to a logically related series of processes or functions that are performed by the business enterprise in combination to achieve a desired goal. For example, a business activity can be as simple as taking an order from a customer, and delivering a product in response. On the other hand a business activity can be as complex as all of the functions performed by a network of servers performing various functions in the completion of an online order for a product.

An “instance” of a business activity is all of the operations performed in completing one instance of the business activity. For example, as described above the business activity could be taking an order online and delivering a product. An instance of that business activity could be one individual's order for a specific product processed from start to finish including all of the processes in between. A business activity is the general case, whereas an instance of a business activity is the specific case. The business activity includes all of the processes necessary to complete one business activity in the general, whereas an instance of a business activity is each of those processes performed in one specific instance. In the case of the financial advisor example, the business activity would be advising the client and all of the functions and processes necessary to reach that objective. The instance of the business activity would be advising a specific client, using those functions and processes toward the goal of advising a specific client. Another instance of that business activity would be the advising of a different client, and so on. Alternatively, an instance of a business activity may also be called a transaction. One transaction could be the purchase of the product online, whereas the business activity would be the general definition of the processes and functions necessary to purchase a product online.

A “checkpoint” or “event” is a single step in the completion of an instance of a business activity. An example of a checkpoint could be the step in the purchase of a product over the internet, where the IT infrastructure of the business attempts to charge the specified amount to the customer. The attempt to charge the card would be a checkpoint. A successful charge made to the card would be another checkpoint. A timeout, no response from the credit card server for a specified period of time, would be a failed checkpoint. A typical timeout for a charge to a user's credit card could be as short as thirty seconds or as long as five minutes, depending upon the implementation.

Checkpoints are defined business activity-wide. So, for example, the process of charging the card, start to finish, would be one complete checkpoint definition. Each checkpoint is a single step in the process, but checkpoint definitions do not have meaning outside of other checkpoints, such as the request for the credit card charge only has meaning as a completed checkpoint once the successful charge is made or the credit card is declined or there is a timeout of the operation. At that point, the checkpoint has meaning in relation to other checkpoints in the process. This means that for each business activity there are several related checkpoint definitions. For the process of completing an order using the Internet, example checkpoints could be web server access request, web server access response, requesting a product be put into an online shopping cart, putting a product into an online shopping cart, attempting to charge the credit card for a specified amount, receiving a response to that credit card charge request, passing the request to ship along to a shipping department and actually shipping the product. Many other checkpoints in that business activity could also be included. Checkpoints are only completed (successful) or not-completed (failed) in instances of a business activity. A business activity is the abstract “definition” of each instance of a business activity. Thus in the abstract placing an order online, a checkpoint is only completed or not completed in the actual placing of a specific order.

“Event data” or “data” as used herein refers to data used or processed in the process of completing or attempting to complete a checkpoint. This data could be an individual's name, address and credit card number. This data could also be an internet protocol address for a user's computer or the server itself. Any data that the user of the checkpoint processing engine desires to log may be included in the “event data” that is created.

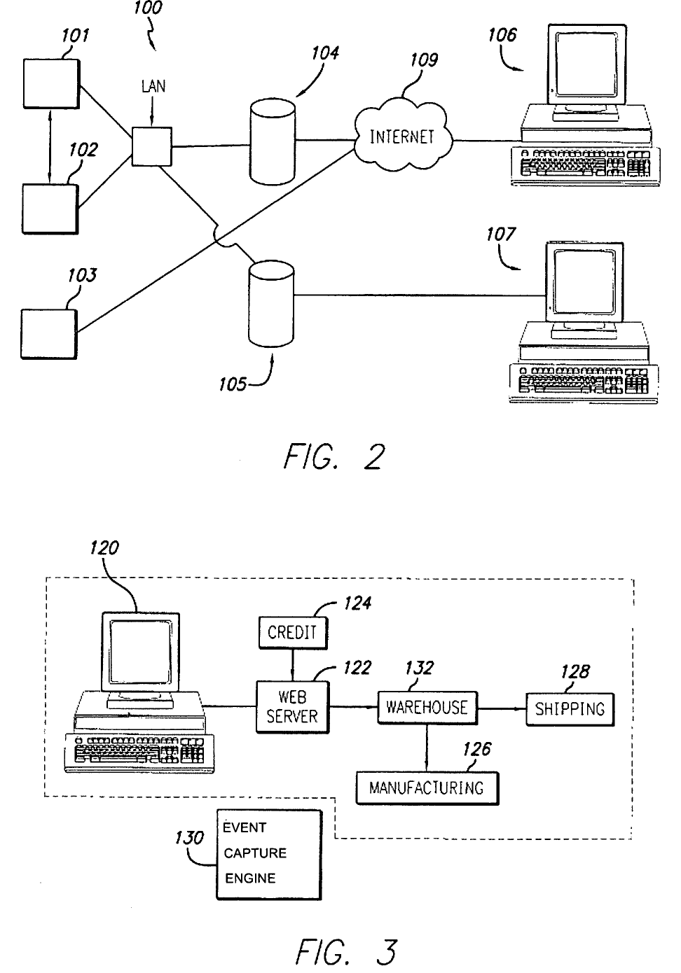

Many modern business activities are executed using a complex series of computers which make up an IT infrastructure. Referring next to FIG. 2, a representation of an example IT infrastructure 100 used by a business to complete a business activity is illustrated. The infrastructure may include a number of computer servers 101, 102, 103 which execute various functions or steps in a business activity. Although only three computer servers are illustrated in FIG. 2, it will be understood that a larger number of servers may be present in the infrastructure as required by the complexity of the business activity. The infrastructure may also include one or more databases 104, 105 for the storage and retrieval of data. Also Internet web servers 106, 107 may also be employed. Various other servers may also be included within an IT infrastructure.

Referring next to FIG. 3 a representative business activity is shown, including the elements on which that business activity is performed. The elements used in this example information technology infrastructure are a personal computer 120, a credit card processing server 124, a web server 122, a warehouse processing server 132, a shipping server 128, and a manufacturing server 126. The manufacturing server will likely be outside of, for example, any retailer's infrastructure, but communication will likely, take place between the company's infrastructure and the outside manufacturer's.

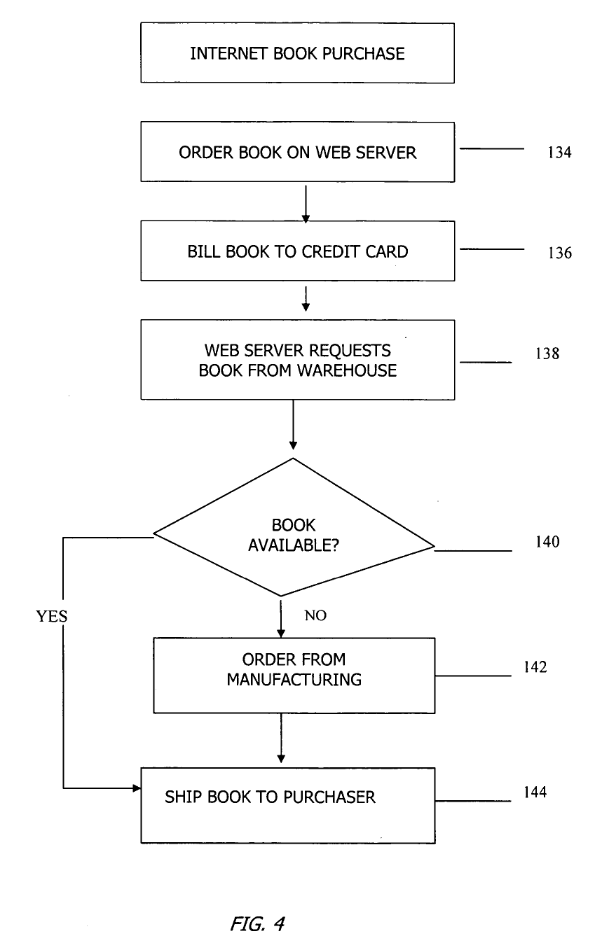

Referring to FIGS. 3 and 4, an example transaction is depicted. In this transaction, the user may place an order for a book 134 using her home computer 120 and using the web server 122. This order would include various data about the transaction including the user's name, address, credit card number, quality of product desired and any number of other data. Because this order is placed for this book using a credit card, the credit server 124 processes that card and bill the user's account 136. The web server 122, then passes data on to the warehouse processing server 132 in step 138, such as the item number, the person's name and address ordering the product. The warehouse server 132 determines if any of that book are available 140 and, if not, contacts the server of the publisher or manufacturer 126 of the book to place an order 142. Once the book is available, the warehouse server 132, then contacts its shipping server 128, sending name and address along for mailing purposes which ships the book to the purchaser 144.

Along the way, each step of this transaction passes data in various forms back and forth across a network. This is a very simple example. In any large-scale online retailing infrastructure, there are multiple web servers, accounting servers, database servers, order processing servers, data storage servers, and the like. Many times, entire clusters or clusters of clusters of servers are used to perform various functions in the online process. In industries other than online retailing, the servers may simply be web servers, file transfer protocol servers, virtual private network gateway servers, and internet portal servers that also pass similar data back and forth.

These examples make it easier to demonstrate that during this process, data is constantly being passed back and forth between the servers. This data is very rarely and almost never in the same or similar format. More recently efforts have been made to use a standard interface format between machines to aid in usability across different software platforms, but in many instances this is not available or simply impossible given the type of tasks being performed. One example of such an effort is the increasing use of extended markup language.

Referring again to FIG. 3, the event capture engine 130 runs on an additional server responsible for listening to receive information from the co-pending patent application entitled Checkpoint Processing Engine with Ser. No. 60/540,959. The event capture engine 130 may stand alone on its own server or be included on a single server along with several other related data processing applications involved in business activity monitoring. Additionally, the capability to model and store the various models of business activities is included within the event capture engine in the preferred embodiment. In alternative embodiments, the modeling capability may be separate from the event capture engine. The modeled business activities data may be stored in a separate database or databases with ready access available to the event capture engine and other related processes. The event capture engine 130 monitors or “listens” to receive data from each checkpoint in every instance of a business activity using “adapters.” Each adapter is a set of instructions the event capture engine uses to extract data from a particular checkpoint event.

Referring again to the prior example, as the book is purchased, data is sent from the purchaser's home computer to the web server over the Internet. Using the adaptor designed to listen for a web page request event, even for one for a particular web page or type of web page, the event capture engine extracts the data from that event for later correlation to a completed instance of a business activity. This captured event data is processed by the co-pending patent application entitled Checkpoint Processing Engine with Ser. No. 60/540,959. Once the checkpoint data has been processed and formatted appropriately, the Transaction Processing Engine described in the co-pending patent application Ser. No. 60/540,962 filed Jan. 30, 2004 receives the data and begins correlating that event with a particular instance of a business activity or transaction.

In the preferred embodiment, the event capture engine 130 may operate in one of two modes. The first mode is the “non-intrusive” mode. This mode maintains most monitoring capabilities and the ability to capture most event data. However, in this mode, actions to correct the data, such as action scripts or corrective scripts, as described in the co-pending Checkpoint Processing Engine may not take place or may be limited in functionality. However, this mode is beneficial in that it requires limited setup and configuration for a particular information technology infrastructure. This non-intrusive mode is facilitated by the business activity architect or modeler. The event capture engine, when in its “passive mode,” is capable of passively monitoring the information technology infrastructure from which event data is to be captured and assessing the types of monitoring that are available. This automatic modeling capability is based primarily on the event capture engine's “knowledge” of the way in which a particular transaction or group of transactions occurs. The event capture engine begins monitoring for data passing amongst the various portions of the information technology infrastructure and then identifies which types of transactions are occurring using a database of known “transaction types.” These transaction types are typically a description of the format in which,, for example, a web server web page request takes. Some manual configuration of transactions is useful in fine-tuning the capabilities of the event capture engine. Other embodiments of the invention may require manual configuration in part or in whole.

In the preferred embodiment, the alternative mode for the event capture engine is the local, more intrusive mode. In this mode, a small program, application or applet is installed on the server to be monitored in order to provide more thorough analysis of the particular business activity. In this mode, corrective actions are more easily implemented and may be used as described in the Checkpoint Processing Engine co-pending patent application Ser. No. 60/540,959. In this mode a direct pipeline of communication is established between the monitoring application and the event capture engine. This pipeline enables real-time alteration of the data if corrective actions are desired. It also enables more access to the event data being created. So, for example, a custom server generating data being passed to a client using an online ordering system may appear as a normal web request under the non-intrusive mode. Much of the data from that web request would be stored. However, if the intrusive mode were used, should the data prove to be inaccurate or incomplete, corrective action scripts could be used to correct the data being used. Additionally, the user of the event capture engine may setup more complicated rules concerning the particular portions of data to capture. For this order, the log of the web server request may be inadequate for the user's needs. More information about the details of the order may be required. In the preferred embodiment of the application, adaptors are included for the vast majority of known interactions between portions of the information technology infrastructure.

In the preferred embodiment, using the passive mode described above the business activity architect may also passively derive the flow of event data to thereby arrive at a complete or partially complete business activity model. This model is used in monitoring for event data and in later correlation of event data to a particular instance of a business activity. For example, in the co-pending Checkpoint Processing Engine application Ser. No. 60/540,959 filed Jan. 30, 2004, the business activity being monitored is used to help the checkpoint processor to know the type of information that should be contained within a particular event. Further, in the co-pending Transaction Processing Engine application Ser. No. 60/540,962 filed Jan. 30, 2004, the business activity being monitored is used to determine the order in which particular events and event data are to be arranged when correlating them to a completed instance of a business activity.

In the preferred embodiment, this business activity model is then used throughout the process of gathering event data, compiling event data and correlating event data to a particular transaction. In the preferred embodiment, this passively-created business activity model may also then be altered by the user. If the series of events being captured that is “discovered” by the event capture engine is only a partially completed list or does not retain some of the dependencies, as described in the Transaction Processing Engine application Ser. No. 60/540,962 filed on Jan. 30, 2004, then the user may modify the “discovered” business activity to include all required events or to alter the order, sequence or dependency of some events. Referring again to FIG. 4, the example business activity is depicted. The event capture engine in passive mode may be able to discover elements 134 through 142, but may miss the final step 144 of shipping the book to the purchaser. The series of steps is discovered by the event capture engine because is “knows” what a step 136 of billing the book to a credit card looks like and knows that it takes place before requests of a product from a warehouse. However, if the final step 144 were missing, the user would be able to add that step to the model of the business activity including any relevant data in that step that should be captured as the event is monitored.

Each adaptor (each monitoring agent designed to monitor a particular type of event and to gather a particular type of event data) monitors only the information that is relevant. The monitoring adaptor is designed, in the preferred embodiment, to avoid needless information processing and network bandwidth usage by ignoring irrelevant information from the event being monitored. Second, the adaptors filter and perform some processing of events at the source. For example, if event data is generated concerning a particular web request, the adaptor may remove the contents of the web page requested and select several pieces of information from the web page to be saved. These are then forwarded to the event capture engine for further processing. This helps the event capture engine from over-utilizing network bandwidth and processing cycles on the central processing unit of the event capture engine server(s). Also, in the preferred embodiment, the event data, once captured by the adaptor is forwarded to the event capture engine server(s) and prioritized. A queuing process is used to prioritize what event data is crucial to continued operations of the events or of monitoring for the events and that data is prioritized over event data that has little immediacy. In other embodiments of the invention, some or all of these adaptor efficiency-driven capabilities may not be implemented or may not be used.

The adaptors themselves capture at least two types of information in the preferred embodiment. The first type of data being captured is the system specific event data. This type of data is information about the type of event that has occurred, on what server or network it occurred, the time it occurred and the date on which it occurred. The adaptor also captures relevant business data contained in the event. The type of business data captured is dependant upon the type of event being monitored. For example, a customer relations management system, a system used in providing customer feedback and other customer-related monitoring capabilities, could pass data to an accounting software. In this process, the customer's name, the account being referenced, the type of customer issue that occurred and other customer-related data may be the captured business data.

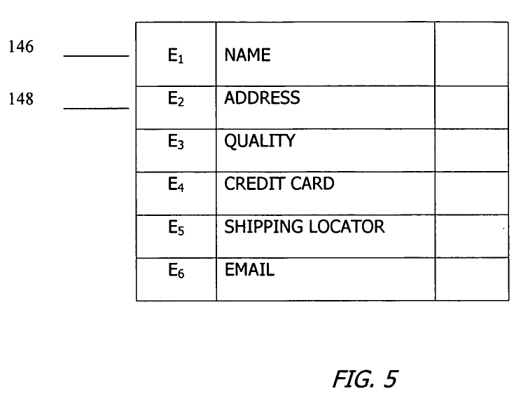

Referring next to FIG. 5, an example of the data that may be passed back and forth among various elements of the information technology infrastructure during a complete instance of a business activity is depicted. Depicted in element 146 is name. In element 148 is address. During each event, however, all of the data will almost certainly never be sent at once or in an easily identifiable format. As this data is captured by the event capture engine, it is saved and then passed along to the Checkpoint Processing Engine as described in the co-pending patent application Ser. No. 60/540,959 filed on Jan. 30, 2004. The event capture engine does not “know” the entirety of the transaction data as depicted here, it only knows that it must capture, for example, name 146 and address 148 in this particular event and save them for later use.

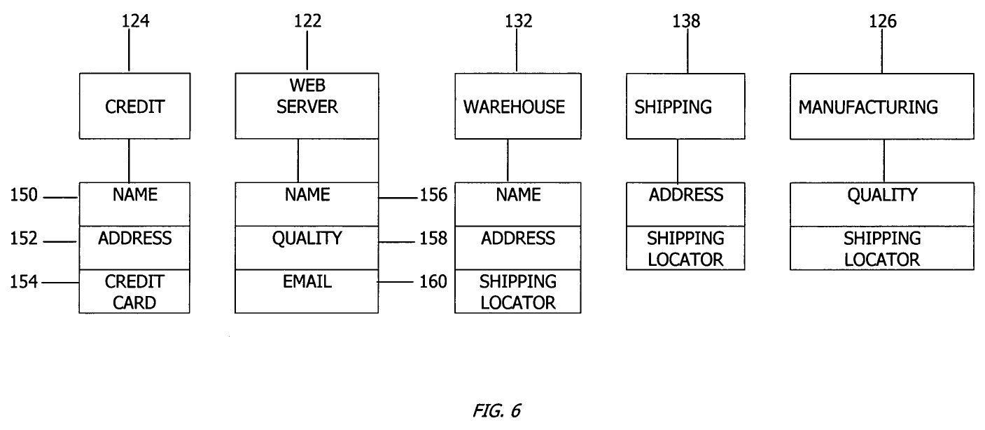

Referring now to FIG. 6, each of the information technology infrastructure elements depicted in FIG. 3 are included, along with the pieces of information each element gives or receives during a communication. For example, the credit card processing server 124 gives and receives the name 150, the address 152 and the credit card number 154. In this example, the credit card processing server 124 receives or transmits no other data elements. The web server 122, receives or transmits the name 156, a quality requirement of the product 158 and the email 160 of the purchaser. Therefore, no single portion of the infrastructure has access to a complete listing of data elements, as depicted in FIG. 5.

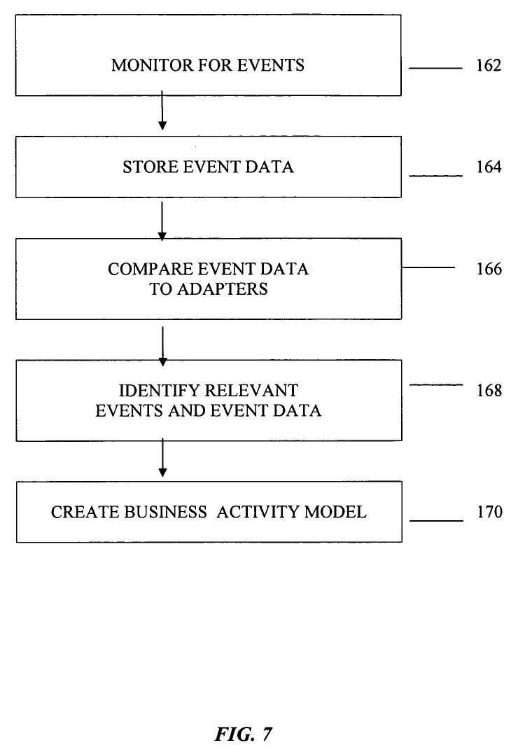

Referring now to FIG. 7, a flowchart depicting the preferred embodiment of the steps in the process of automatic business modeling is depicted. The first step is to monitor for events as depicted in element 162. This step is used to passively monitor a particular information technology infrastructure for known events using the formats from adapters. This monitored event data is then stored in step 164. This step simply gathers a large portion of event data so that it can be generalized and used as a base from which to identify the various types of events occurring in a particular business activity. Next, the stored event data is compared to the known types of events using the adapters in step 166. There are adapters for virtually every known type of business activity event. These adapters are then used to identify relevant events and event data to be captured in step 168. Because the events are now recognized, the adaptor can be used to determine the relevant data within each event. Once this has been determined, the event has been modeled. The final step in the preferred embodiment is the create the business activity model using the discovered events and relevant event data as depicted in step 170. In this step, the adapters are used to determine in what order the events probably occur. This is then used to propose a likely business activity model. This model may then be modified by the user if modification is necessary or desired. In alternative embodiments, some steps may be removed or added. Alternate methods may be employed other than using adapters to determine the type of business activity being monitored.

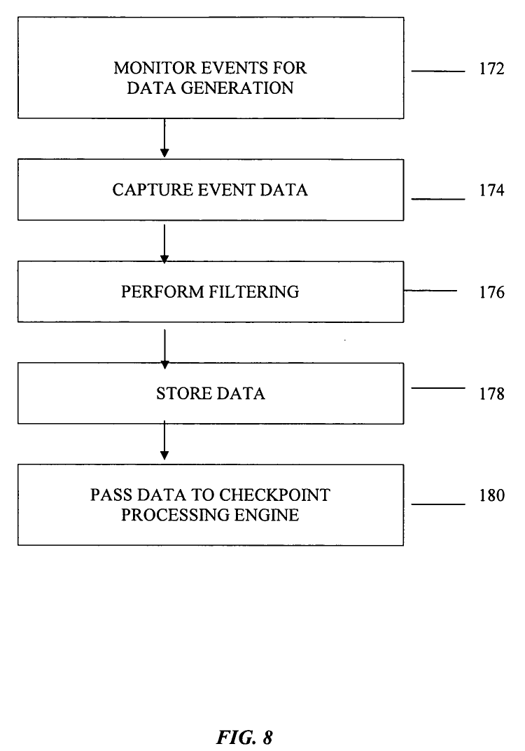

Referring now to FIG. 8, the steps in capturing event data are depicted. In the preferred embodiment, the first step is to monitor events for data generation as depicted in element 172. In this step, whether using the above-described non-intrusive or intrusive modes, the event capture engine monitors for events so that event data may be extracted. In the next step, event data is captured 174. This requires that the event capture engine be monitoring when the event takes place and that the data used and processed be captured using the adapters as described above. The third step in the preferred embodiment is to apply some filtering to the data as depited in element 176, before passing it on to the event capture engine. This step is optional and may be excluded altogether, but in the preferred embodiment it has been shown to be more efficient to perform this function on the server that generated the event data. Next, the event data is stored in step 178 for later use. Finally, the data is passed on to the Checkpoint Processing Engine as described in the co-pending patent application Ser. No. 60/540,959 filed Jan. 30, 2004 as depicted in element 180. In alternative embodiments, other “subscribing” processes may receive the event data. The event capture engine has functionality that enables subscription to a particular event or all events of a business activity to a particular process. This means that all of the event data will be forwarded to a process, for either a particular event or all events in a business activity.

In the preferred embodiment of the invention, the capability also exists to “playback” an event. This means that the event capture engine can emulate the activity of the events that have occurred to any process or server as if the events were occurring again. This functionality can be used if one server goes down while attempting to contact another in the midst of many transactions to “jump start” a process again, mid-stream. It may also be used to evaluate whether a fix to a problem has actually been implemented. To the process that the event data is being fed, its as if the series of events are occurring at that moment. The playback can be for a series of events, a completed single transaction or a series of one type of event. The events, when played back using this functionality, occur in the same order and time-differential that they originally occurred.

Accordingly, an event capture engine has been described. It is to be understood that the foregoing description has been made with respect to specific embodiments thereof for illustrative purposes only. The overall spirit and scope of the present invention is limited only by the following claims, as defined in the foregoing description.

1. A method of monitoring an event in a business activity comprising the steps of:
determining when at least one event has occurred in a business activity;
monitoring the event data used in said at least one event;
collecting said event data; and
storing said event data.

2. A digital computer system programmed to perform the steps specified in the method of claim 1.

3. Computer-readable media containing programming designed to accomplish the method of claim 1.

4. The method of claim 1, further comprising the additional step of filtering said event data prior to storing.

5. The method of claim 1, further comprising the additional step of playing back said event data for said at least one event.

6. The method of claim 1, wherein said collecting step takes place using at least one adapter.

7. The method of claim 1, further comprising the additional step of forwarding said event data to a process for correlation to an instance of a business activity.

8. The method of claim 1, further comprising the additional step of modeling said business activity prior to said determining step.

9. The method of claim 8, wherein said modeling step is completed using at least one adapter.

10. A method of monitoring an event in a business activity comprising the steps of:
modeling said business activity;
determining when at least one event has occurred in a business activity;
monitoring the event data used in said at least one event;
collecting said event data;
filtering said event data;
storing said event data; and
forwarding said event data for correlation to an instance of a business activity.

11. A digital computer system programmed to perform the steps specified in the method of claim 10.

12. Computer-readable media containing programming designed to accomplish the method of claim 10.

13. A computer-based apparatus for monitoring a business activity comprising:
modeling means for modeling said business activity;
processing means connected to said modeling means for determining when at least one event has occurred in a business activity;
monitoring means connected to said processing means for monitoring the event data used in said at least one event;
collection means connected to said monitoring means for collecting said event data;
filtration means connected to said collection means for filtering said event data;
storage means connected to said collection means for storing said event data; and
output means connected to said storage means for forwarding said event data for correlation to an instance of a business activity.
